(19) United States
(12) Patent Application Publication
(10) Pub. No.: US 2008/0130524 A1
(43) Pub. Date: Jun. 5, 2008

(54) SYSTEM AND METHOD FOR USER ACCOUNT PORTABILITY ACROSS COMMUNICATION SYSTEMS

(75) Inventors: Ben VOLACH, Richmond, VA (US); Sharon Fridman, London (GB)

Correspondence Address: PATENT ADMINISTRATOR;KATTEN MUCHIN ROSENMAN LLP, 1025 THOMAS JEFFERSON STREET, N.W., EAST LOBBY: SUITE 700, WASHINGTON, DC, 20007-5201, US

(73) Assignee: NeuStar, Inc., Sterling, VA (US)

(21) Appl. No.: 11/844,240

(22) Filed: Aug. 23, 2007

Related U.S. Application Data
(60) Provisional application No. 60/839,430, filed on Aug. 23, 2006.

(51) Int. Cl. H04L 12/16

(52) U.S. Cl. 370/259

(57) ABSTRACT

The present invention is directed to a system and method for user account portability across communication systems. The present invention allows users to switch communication service providers and retain their service and account profile information when moving between communication environments. The user can switch to a new communication service provider without losing the assets of the user's settings and account profile that the user generated for the previous communication service provider. The user need not re-enter or re-configure various account settings after moving to the new communication service provider, as such information is propagated from the user's previous service provider. Thus, users can enjoy service continuity and can choose any communication service provider according to their considerations (e.g., service level, cost, benefits, or the like), and not incur service usage penalties due to the switch.

The present application claims priority under 35 U.S.C. § 119(e) to U.S. Provisional Application No. 60/839,430, filed on Aug. 23, 2006, the entire contents of which are hereby incorporated by reference herein.

### BACKGROUND

1. Field of the Invention

The present invention relates to communication systems. More particularly, the present invention relates to a system and method for user account portability across communication systems.

2. Background Information

Communication environments are generally comprised of communication services provided to users. The users can create and populate various types of service profile and account information for different types of communication applications and services including, but not limited to, messengers (e.g., instant messaging (IM), short message service (SMS), and the like), gaming and multi-player gaming platforms, dating services, voice and video communication, chat services, internet service providers (ISPs), and the like.

For example, FIG. 1 is a diagram illustrating a conventional model in which service profile information is located and maintained within the service provider network. The communication service provider network 100 is maintained and operated by a network provider, ISP, or the like, and services a plurality of users 105. The users 105 can communicate or interact with services and other users (both inside and outside the communication service provider network 100) using suitable wireless and/or wired communication devices or platforms, such as, for example, a personal computer (PC), a mobile or handheld device (e.g., a cellular telephone or personal digital assistant (PDA)), or other like communication endpoint. Such wireless and/or wired communication occurs through a suitable wireless and/or wired network 110. The specific communication services (e.g., IM, gaming, and the like) are provided to the users 105 using an appropriate service enabler 115. The service profiles and account information 120 of the users 105 are associated with and maintained by the service enabler 115, and, therefore, are tied to the particular service enabler 115 or service provider. When users 105 switch or otherwise transfer communication services to another provider (e.g., to receive better service, lower cost, or for other reasons), the users 105 will lose their service profile, preferences, history, account settings, and other like information 120.

Therefore, there is a need to allow users to switch service providers, and retain their service and account profile information when moving to another communication environment.

### SUMMARY OF THE INVENTION

A system and method are disclosed for user account portability across communication systems. In accordance with exemplary embodiments of the present invention, according to a first aspect of the present invention, a system for user account portability across communication systems includes a user account management server module capable of communicating with a plurality of communication service operators. The user account management server module includes a user account information repository module. A user is configured to utilize a first communication service provided by a first communication service operator. The user account information repository module is configured to maintain communication account information of the user for configuring the first communication service for the user. The user switches to a second communication service provided by a second communication service operator. The user account information repository module is configured for porting the communication account information of the user from the first communication service operator to the second communication service operator for configuring the second communication service for the user.

According to the first aspect, the user account management server module can include a communication account information management module. The communication account information management module can be configured to manage communication account information of users. The user account management server module can include a communication module. The communication module can be configured to communicate communication account information of users. The communication module can be configured to support a plurality of communication access protocols. Each communication service operator can include a communication server module in communication with the user account management server module. The communication server module can be configured to query the user account management server module for communication account information of users.

According to the first aspect, each of the first and second communication services can comprise, for example, an instant messaging (IM) service or other like communication service or system. For example, the communication account information of the user can comprise, for example, IM account information or the like. For purposes of illustration and not limitation, the IM account information can comprise at least one of a user profile, user-defined content, a buddy list, a block list, an authorization list, an IM history, message delivery settings, IM groups, communication policy, and user preferences. The communication account information of the user can comprise user account information for each of a plurality of service accounts. The communication account information of the user can comprise a plurality of user identity selectors for identifying user account information for each of the plurality of service accounts. The communication account information of the user can comprise shared account information capable of being used by a plurality of communication services. Each user can comprise or otherwise be associated with a user communication device. According to an exemplary embodiment of the first aspect, each user communication device can comprise the user account management server module. The system can include a user account administration module in communication with the user account management server module. The user account administration module can be configured to administer the user account management server module and the communication account information of the users.

According to a second aspect of the present invention, a system for porting user accounts between communication environments includes a user communication device. The user communication device is adapted to utilize a first communication service provided by a first communication service operator. The user communication device includes client application structure adapted to execute on the user communication device. The client application structure includes account information maintenance structure. The account information maintenance structure is adapted to maintain communication account information associated with the user communication device for configuring the first communication service for use by the user communication device. The user communication device is switched to a second communication service provided by a second communication service operator. The account information maintenance structure is adapted for porting the communication account information from the first communication service operator to the second communication service operator for configuring the second communication service for use by the user communication device.

According to the second aspect, the client application structure can include account information management structure. The account information management structure can be adapted to manage communication account information associated with the user communication device. The client application structure can include communication structure. The communication structure can be adapted to communicate communication account information associated with the user communication device. Each communication service operator can include a communication server. The communication server can be capable of being updated with the communication account information maintained by the account information maintenance structure of the user communication device. A user account administration server can be in communication with the client application structure. The user account administration module is adapted to administer the client application structure and the communication account information associated with the user communication device.

According to a third aspect of the present invention, a method of porting user accounts between communication environments includes the steps of: maintaining communication account information of a user for configuring a first communication service provided by a first communication service operator; switching the user from the first communication service to a second communication service provided by a second communication service operator; and porting the communication account information of the user from the first communication service operator to the second communication service operator for configuring the second communication service.

According to the third aspect, the method can include one or more of the following steps: generating the communication account information of the user; managing communication account information of the user; and communicating communication account information of the user. The porting step can include the step of: querying for communication account information of the user. Each of the first and second communication services can comprise, for example, an IM service or other like communication service or system. For example, the communication account information of the user can comprise, for example, IM account information or the like. For purposes of illustration and not limitation, the IM account information can comprise, for example, at least one of a user profile, user-defined content, a buddy list, a block list, an authorization list, an IM history, message delivery settings, IM groups, communication policy, and user preferences. The communication account information of the user can comprise user account information for each of a plurality of service accounts. The communication account information of the user can comprise a plurality of user identity selectors for identifying user account information for each of the plurality of service accounts. The communication account information of the user can comprise shared account information capable of being used by a plurality of communication services. The method can include the step of: administering the communication account information of users.

According to a fourth aspect of the present invention, a system for user account portability across communication systems includes means for managing user accounts. The user account managing means is capable of communicating with a plurality of communication service operators. The user account managing means includes means for maintaining user account information. A user is configured to utilize a first communication service provided by a first communication service operator. The user account information maintaining means is configured to sustain communication account information of the user for configuring the first communication service for the user. The user switches to a second communication service provided by a second communication service operator. The user account information maintaining means is configured for porting the communication account information of the user from the first communication service operator to the second communication service operator for configuring the second communication service for the user.

According to the fourth aspect, the user account managing means can include means for managing communication account information. The communication account information managing means can be configured to manage communication account information of users. The user account managing means can include means for communicating information. The information communicating means can be configured to communicate communication account information of users. The information communicating means can be configured to support a plurality of communication access protocols. Each communication service operator can include a communication server module in communication with the user account managing means. The communication server module can be configured to query the user account managing means for communication account information of users.

According to the fourth aspect, each of the first and second communication services can comprise, for example, an IM service or other like communication service or system. For example, the communication account information of the user can comprise, for example, IM account information or the like. For purposes of illustration and not limitation, the IM account information can comprise, for example, at least one of a user profile, user-defined content, a buddy list, a block list, an authorization list, an IM history, message delivery settings, IM groups, communication policy, and user preferences. The communication account information of the user can comprise user account information for each of a plurality of service accounts. The communication account information of the user can comprise a plurality of user identity selectors for identifying user account information for each of the plurality of service accounts. The communication account information of the user can comprise shared account information capable of being used by a plurality of communication services. Each user can comprise or otherwise be associated with a user communication device. According to an exemplary embodiment of the fourth aspect, each user communication device can comprise the user account managing means. The system can include means for administering user accounts in communication with the user account managing means. The user account administering means can be configured to administer the user account managing means and the communication account information of the users.

According to a fifth aspect of the present invention, a system for porting user accounts between communication environments includes a user communication device. The user communication device is adapted to utilize a first communication service provided by a first communication service operator. The user communication device includes means for managing account information. The account information managing means includes means for supporting account information. The account information supporting means is adapted to maintain communication account information associated with the user communication device for configuring the first communication service for use by the user communication device. The user communication device is switched to a second communication service provided by a second communication service operator. The account information supporting means is adapted for porting the communication account information from the first communication service operator to the second communication service operator for configuring the second communication service for use by the user communication device.

According to the fifth aspect, the account information managing means can include means for managing communication account information. The communication account information managing means can be adapted to manage communication account information associated with the user communication device. The account information managing means can comprise means for communicating. The communicating means can be adapted to communicate communication account information associated with the user communication device. Each communication service operator can include a communication server. The communication server can be capable of being updated with the communication account information maintained by the account information supporting means of the user communication device. A means for administering user accounts can be in communication with the account information managing means. The user account administering means can be adapted to administer the account information managing means and the communication account information associated with the user communication device.

### BRIEF DESCRIPTION OF THE DRAWINGS

Other objects and advantages of the present invention will become apparent to those skilled in the art upon reading the following detailed description of preferred embodiments, in conjunction with the accompanying drawings, wherein like reference numerals have been used to designate like elements, and wherein:

FIG. 1 is a diagram illustrating a conventional model in which service profile information is located and maintained within the service provider network.

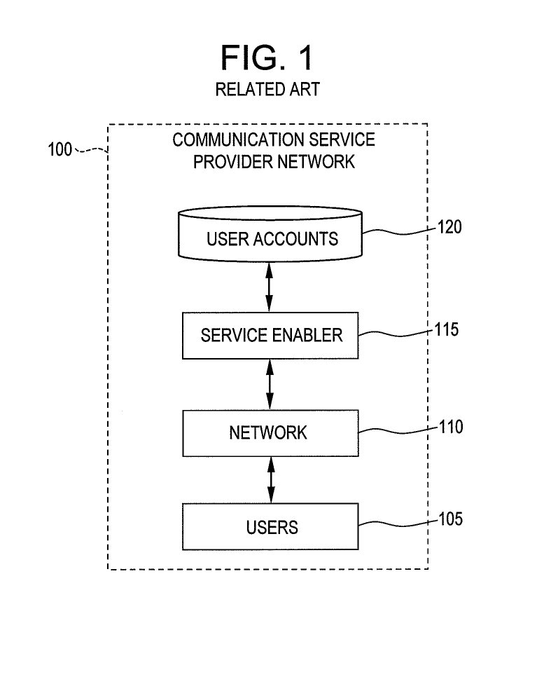

FIG. 2 is a block diagram illustrating a system 200 for user account portability across communication systems, in accordance with an exemplary embodiment of the present invention.

FIG. 3 is a diagram illustrating the types of instant messaging account information that can be maintained as the communication account information for different users, in accordance with an exemplary embodiment of the present invention.

FIG. 4 is a block diagram illustrating a system for porting user accounts between communication environments, in accordance with an alternative exemplary embodiment of the present invention.

FIG. 5 is a flowchart illustrating steps for porting user accounts between communication environments, in accordance with an exemplary embodiment of the present invention.

### DETAILED DESCRIPTION OF THE PREFERRED EMBODIMENTS

Exemplary embodiments of the present invention are directed to a system and method for user account portability across communication systems. The present invention can allow users to switch communication service providers and retain their service and account profile information when moving between communication environments. The user can switch between mobile operators, internet service providers (ISPs), gaming platforms, or other communication services or platforms regardless of the type of communication supported and the communication networks involved. The user can bind or otherwise be associated with a new communication service provider without losing the assets of the user's settings and account profile that the user has created and populated for the old or previous communication service provider. According to exemplary embodiments of the present invention, the user need not re-enter or re-configure various account settings after moving to the new communication service provider, as such information is propagated from the user's previous service provider. Thus, users can enjoy service continuity and can choose any communication service provider according to their considerations (e.g., service level, cost, benefits, or the like), and not incur service usage penalties due to the switch.

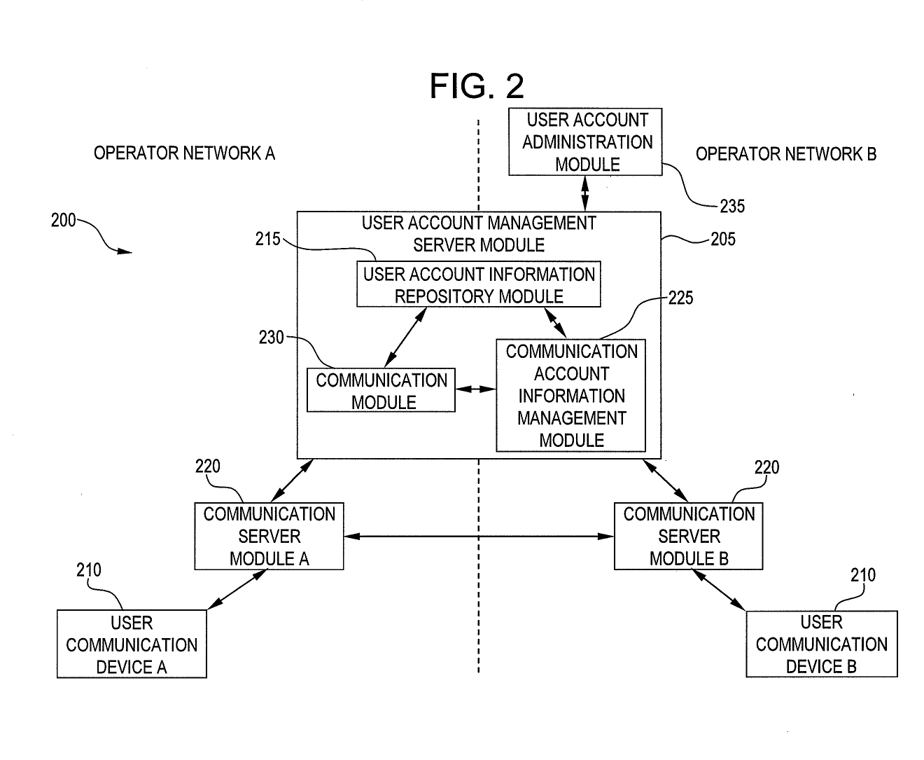

These and other aspects and embodiments of the present invention will now be described in greater detail. FIG. 2 is a block diagram illustrating a system 200 for user account portability across communication systems, in accordance with an exemplary embodiment of the present invention. The system 200 includes a user account management server module 205. The user account management server module 205 is capable of communicating with a plurality of communication service operators or other service providers. For purposes of illustration and not limitation, the user account management server module 205 can be in communication with the communication service operators represented by operator network A and operator network B. Operator networks A and B can each comprise any suitable type of wireless and/or wired communication network. For example, each of operator networks A and B can be operated or otherwise managed by any appropriate type of network operator, including, but not limited to a Mobile Network Operator (MNO), a mobile virtual network operator, a wireless service provider, a wireless carrier, a mobile phone operator, a cellular company or organization, a fixed network operator, a converged network operator, or any suitable combination thereof. Skilled artisans will recognize that any suitable number (e.g., operator network 1, operator network 2, operator network 3, . . . , operator network M, where M is any appropriate number) and kinds (e.g., wired, wireless, or combination thereof) of networks can be used with system 200 in accordance with exemplary embodiments.

According to exemplary embodiments, a user of the system 200 can utilize a first communication service provided by a first communication service operator. Each user can comprise or otherwise be associated with, for example, a user communication device 210. For example, a user of the communication services provided by operator network A (e.g., user A) can comprise or be associated with the user communication device A. Additionally, a user of the communication services provided by operator network B (e.g., user B) can comprise or be associated with the user communication device B. However, any suitable number of users and user communication devices 210 (e.g., user communication device 1, user communication device 2, user communication device 3, . . . , user communication device N, where N is any appropriate number) can use or be used with the system 200 in accordance with exemplary embodiments of the present invention. Each user communication device 210 can comprise any suitable type of wireless or wired communication module or device that is capable of receiving and transmitting messages and other information using any appropriate type of communication service. For example, each of the user communication devices 210 can comprise a mobile or handheld device (e.g., cellular telephone, personal digital assistant (PDA)), a personal computer (PC), or the like.

The user account management server module 205 can provide centralized management of user account information across any and all operator networks. For example, the user account management server module 205 can be administered by an independent trustee, a third party communication policy provider, one of the communication service operators or providers, or other suitable party so that all communication systems have access to the communication account information of each user. Accordingly, the user account management server module includes a user account information repository module 215. The user account information repository module 215 is configured to maintain or otherwise sustain or support communication account information of the user for configuring the first communication service for the user. For example, the user account information repository module 215 can maintain the communication account information of user A for configuring or otherwise tailoring the communication services provided to user A by operator network A. Additionally, the user account information repository module 215 can maintain the communication account information of user B for configuring or otherwise tailoring the communication services provided to user B by operator network B. However, the user account information repository module 215 can maintain or otherwise sustain the communication account information for any suitable number of users across any appropriate number of communication systems. For example, the user account information repository module 215 can be comprised of any suitable type of computer-readable or other computer storage medium capable of storing communication account information in electrical or electronic form, and can include suitable logic (e.g., hardware, firmware, software, or a appropriate combination thereof) for maintaining and sustaining such information.

According to exemplary embodiments, each user can switch communication service providers at any time. In other words, the user can switch or otherwise transfer from the first communication service to a second communication service provided by a second communication service operator. For purposes of illustration and not limitation, user A can switch communication services to those provided by operator network B, while user B can switch communication services to those provided by operator network A. The user account information repository module 215 is configured for porting the communication account information of the user from the first communication service operator to the second communication service operator for configuring the second communication service for the user. For example, the user can issue (either manually or automatically) a suitable indication, signal, command, or other request via their user communication device 210 to their communication service provider (either “old” or “new”) or directly to the user account management server module 205 to initiate the porting of the user's communication account information from their “old” communication service provider to their “new” communication service provider.

For purposes of illustration and not limitation, after user A switches communication services to those provided by operator network B, the operator network B can query the user account information repository module 215 for the communication account information of user A. Additionally, after user B switches communication services to those provided by operator network A, the operator network A can query the user account information repository module 215 for the communication account information of user B. In both cases, the fetched or otherwise retrieved communication account information can be used by the newly-switched operator networks to configure the respective communication services to tailor or personalize those services to the settings and preferences previously established by the user. Thus, neither user A nor user B need re-enter or re-configure various account settings after moving to the new communication service operator or provider, as such information is propagated from the user's previous service provider. Thus, users can enjoy service continuity and can choose any communication service provider according to their considerations (e.g., service level, cost, benefits, or the like).

According to exemplary embodiments, the communication account information can comprise any suitable type and combination of user preferences or settings, account settings, service profiles, history information, policies or rules, user data, and/or any other like configuration information capable of specifying, configuring, tailoring, and personalizing the communication services offered by a communication service provider to the needs, requirements, and desires of the user. For example, the communication account information can comprise appropriate service definitions for a Resource List Server (RLS), or other service-oriented user-defined communication account information. Merely for purposes of illustration and not limitation, each of the communication services provided by operator networks A and B can comprise, for example, an instant messaging (IM) service or other like communication service or system, and the communication account information of user A and user B can comprise, for example, IM account information or other like communication account information.

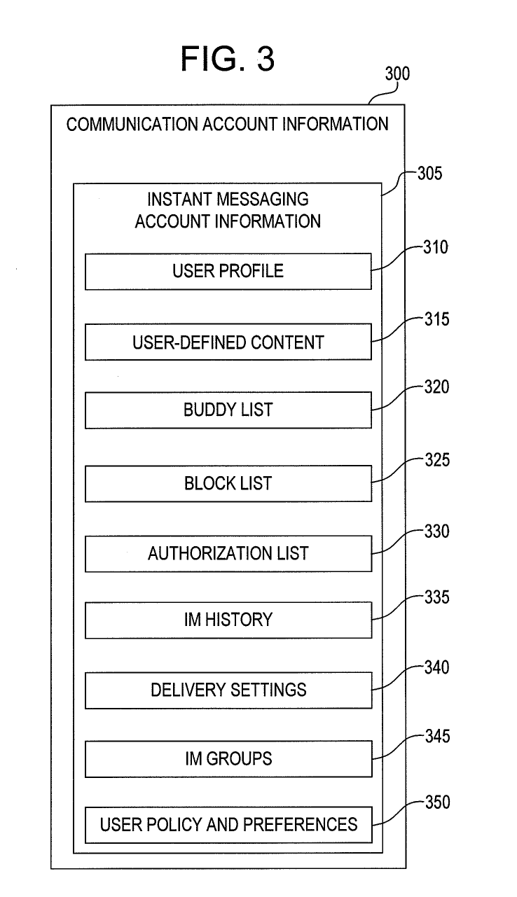

Merely for purposes of illustration and not limitation, FIG. 3 is a diagram illustrating the types of IM account information that can be maintained as the communication account information 300 for users A and B by the user account information repository module 215, in accordance with an exemplary embodiment of the present invention. The IM account information 305 can include, but is not limited to, one or more user profiles 310, user-defined content 315, one or more buddy lists 320, one or more block lists 325, one or more authorization lists 330, IM history 335, delivery settings 340, one or more IM groups 345, user policies and preferences 350, and other like communication account information 300 that is related to or otherwise associated with an IM service. The particular communication account information for each user will depend on different factors, including, but not limited to, the type and nature of the communication services and platforms used, operator policies and preferences, user policies and preferences, and other like factors.

For each user, the communication account information can maintain account information for a single or particular service (e.g., IM) or user account information for multiple service accounts (e.g., IM, gaming, chat, and the like). For example, the communication account information for user A can include the preferences and account settings for both operator network A and operator network B. Additionally, if the communication account information for a user comprises separate user account information for each of a plurality of service accounts, the communication account information can include a plurality of user identity selectors or other unique identifiers for identifying user account information for each of the plurality of service accounts. In other words, such user identity selectors can be used to select and identify the particular service and user profile for each service account. According to an additional exemplary embodiment, instead of maintaining separate user account information for each service used by a user, the communication account information can comprise shared account information capable of being used by a plurality of communication services. In other words, such shared account information can include generic settings, preferences, and account information that can be used by multiple services. Any and all such communication account information can be owned by any suitable entity who uses or otherwise interacts with the system 200, including the user, the communication service provider, a country or region, a trustee organization, or any other entity.

According to exemplary embodiments, the user account information repository module 215 can be configured for porting the communication account information between communication systems in any suitable manner. According to one exemplary embodiment, the user account information repository module 215 can include appropriate look-up tables that can used to retrieve the communication account information for each user. Such look-up tables can be stored in a suitable computer memory or other computer storage device internal to or in communication with the user account information repository module 215 and/or the user account management server module 205. For purposes of illustration and not limitation, Table 1 illustrates an exemplary lookup table that can be used to manage the communication account information for each user.

TABLE 1
Exemplary communication account information for users.

| COMMUNICATION | | |
|---|---|---|
| ACCOUNT | | |
| INFORMATION | USER A | USER B |
| User Profile | USER_PROFILE_A | USER_PROFILE_B |
| User Defined Content | USER_CONTENT_A | None |
| History | 60 days | 30 days |
| Delivery Settings | USER_DELIVERY_A | USER_DELIVERY_B |
| Preferences | USER_PREFERENCES_A | USER_PREFERENCES_B |

In Table 1, the “Communication Account Information” column specifies the various account settings, profiles, and preferences maintained for each user in the remaining columns of the table. For example, the “User Profile” for User A is “USER_PROFILE_A,” and for User B is “USER_PROFILE_B.” For “History,” User A has specified that a history of communication transactions over the past 60 days are to be saved, while User B has specified that such a history should be limited to 30 days. Additionally, User A has created “User Defined Content,” and such content is specified in “USER_CONTENT_A” (e.g., a collection of images, videos, or other multimedia, graphical, and/or textual information). User B, however, has not created, generated, or otherwise defined any such content, as indicated by “None.” Using a lookup table such as that illustrated in Table 1, the user account information repository module 215 can maintain any and all suitable communication account information for all users so that the information can be ported between communication systems as users switch communication service operators or providers. Such a lookup table can be configured to maintain any suitable type and number of communication account information depending on, for example, the number of users of the system 200. Additionally, as skilled artisans will recognize, the nature and content of the information contained in such a look-up table will depend on, for example, the type and nature of communication services and platforms supported, operator policies and preferences, user policies and preferences, and other like factors.

Alternatively, suitable Boolean or other logic or rules can be used for maintaining and porting the communication account information between communication systems for each user. For example, continuing with the present illustration, Boolean logic can be used to determine that IF a query is made for “History” settings for User A, THEN return “60 days.” Likewise, Boolean logic can be used to determine that IF a query is made for “History” settings for User B, THEN return “30 days.” The complexity of such logic or rules will depend on the nature and type of the communication account information maintained and supported by the various communication systems and the system 200, as well as other like factors. More complex mechanisms, such as neural networks, can be adapted to “learn” how to respond to such communication account information queries or requests. For example, according to an exemplary embodiment, the user account information repository module 215 can “learn” that the “History” setting for User A is “60 days,” while the “History” setting for User B is “30 days.” Such information can be fed back to the user account information repository module 215 to allow such “learning” to take place and to refine these or other like algorithms.

To facilitate retrieval of the communication account information from the user account information repository module 215, each communication service operator or provider can include a communication server module 220. Each communication server module 220 can be in communication with the user account management server module 205, with the respective user communication devices 210, and with each other (and other like modules) to facilitate communication transactions throughout the system 200. For example, operator network A can include communication server module A that is in communication with user communication device A, while operator network B can include communication server module B that is in communication with user communication device B. Each communication server module 220 is configured to query the user account management module 205 to fetch or otherwise retrieve communication account information of users. The number and type of such communication server modules 220 will depend on the number and type of communication services offered in each operator network. For example, each communication server module 220 can comprise a suitable type of service enabler, such as, for example, an IM Service Center (e.g., an IM enabler), a Short Message Service Center (SMSC), a gaming or other application server, or the like.

To manage the communication account of each user, the user account management server module 205 can include a communication account information management module 225. The communication account information management module 225 can be configured to manage the communication account information of users. Any suitable preferences, account settings, or other communication account information can be managed or manipulated by the communication account information management module 225, and any such information can be stored or otherwise maintained by the user account information repository module 215 with which the communication account information management module 225 can be in communication. For example, the user may specify a preference or setting to block particular communication transactions with certain other users (e.g., by creating a “block list”). Accordingly, the user (via the user communication device 210) can suitably interact with the communication account information management module 225 to create and populate such a block list, and the resulting list can be stored and maintained by the user account information repository module 215. Such a block list will “move” with the user if that user subsequently decides to switch to another communication service operator, so that the user will not have to re-populate their block list after changing service providers.

The communication account information management module 225 can also be used to manage preferences or settings from other entities that use or are otherwise associated with the system 200, such as one or more communication service operators. Such operators can establish appropriate preferences or policies that are applicable to individual users or groups of users, all of which can be managed and maintained according to exemplary embodiments. For example, a particular operator (e.g., the communication service operator of operator network A) can establish a preference or policy that the user account information repository module 215 is to maintain a 60-day history of all communication transactions carried on by each user of operator network A. According to exemplary embodiments, such a communication transaction history (as well as the history setting) can be ported with the user when the user switches service providers (e.g., switching from operator network A to operator network B) so that the history is not lost.

The user account management server module 205 can include a communication module 230. The communication module 230 is configured to communicate communication account information of the users. However, each of the modules of the user account management module 205 can use the communication module 230 to communicate any suitable type of information to, for example, users, operators, and other entities using or otherwise in communication with the system 200. The communication module 230 can be adapted to use any suitable type of wireless or wired communication link, connection, or medium that uses an appropriate form of wireless or wired communication mechanism, protocol, or technique, or any suitable combination thereof, to communicate with the various entities of the system 200. In other words, the communication module 215 can be configured to use any or all of a plurality of communication access protocols to support various suitable types of networks, security settings, communication environments, and the like.

The system 200 can include a user account administration module 235 in communication with the user account management server module 205 (e.g., via the communication module 230). The user account administration module 235 can be configured to administer or otherwise manage the user account management server module 205 (or any of the modules thereof) and the communication account information of the users. The user account administration module 235 can be used by, for example, a service provider, a system administrator, operator, or the like to manage and maintain any or all aspects of the user account management server module 205.

Those of ordinary skill in the art will recognize that each of the modules of the system 200 can be located locally to or remotely from each other, while use of the system 200 as a whole still occurs within a given country, such as the United States. For example, merely for purposes of illustration and not limitation, the user account management server module 205 (including the user account information repository module 215, the communication account information management module 225, and the communication module 230) can be located extraterritorially to the United States (e.g., in Canada and/or in one or more other foreign countries). However, the user communication devices 210 (and the communication server modules 220) can be located within the United States, such that the control of the system 200 as a whole is exercised and beneficial use of the system 200 is obtained by the user within the United States.

Each of modules of the system 200, including the user account management server module 205 (including the user account information repository module 215, the communication account information management module 225, and the communication module 230), the user communication devices 210, and the communication server modules 220, or any combination thereof, can be comprised of any suitable type of electrical or electronic component or device that is capable of performing the functions associated with the respective element. According to such an exemplary embodiment, each component or device can be in communication with another component or device using any appropriate type of electrical connection or communication link (e.g., wireless, wired, or a combination of both) that is capable of carrying such information. Alternatively, each of the modules of the system 200 can be comprised of any combination of hardware, firmware and software that is capable of performing the functions associated with the respective module.

Alternatively, each, any, or all of the components of the system 200 (including the user account management server module 205, the user communication devices 210, and the communication server modules 220) can be comprised of one or more microprocessors and associated memory(ies) that store the steps of a computer program to perform the functions of one or more of the modules of the system 200. The microprocessor can be any suitable type of processor, such as, for example, any type of general purpose microprocessor or microcontroller, a digital signal processing (DSP) processor, an application-specific integrated circuit (ASIC), a programmable read-only memory (PROM), an erasable programmable read-only memory (EPROM), an electrically-erasable programmable read-only memory (EEPROM), a computer-readable medium, or the like. The memory can be any suitable type of computer memory or any other type of electronic storage medium, such as, for example, read-only memory (ROM), random access memory (RAM), cache memory, compact disc read-only memory (CDROM), electro-optical memory, magneto-optical memory, or the like. As will be appreciated based on the foregoing description, the memory can be programmed using conventional techniques known to those having ordinary skill in the art of computer programming to perform the functions of one or more of the modules of the system 200. For example, the actual source code or object code of the computer program or other like structure can be stored in the memory.

The system 200 can include suitable additional modules as necessary to assist or augment the functionality of any or all of the modules of the system 200. For example, the system 200 can include additional database or storage modules that can be internal to or communication with the user account management server module 205. Such storage modules can be configured to store any suitable type of information generated or used by or with the system 200. The storage modules can be comprised of any suitable type of computer-readable or other computer storage medium capable of storing information in electrical or electronic form.

Alternative architectures or structures can be used to implement the various functions of the system 200 as described herein. For example, functions from two or more modules can be implemented in a single module, or functions from one module can be distributed among several different modules. For example, the communication account information management module 225 can form a component of the user account information repository module 215, such that the user account information repository module 215 is configured to perform the functionality of that (incorporated) module.

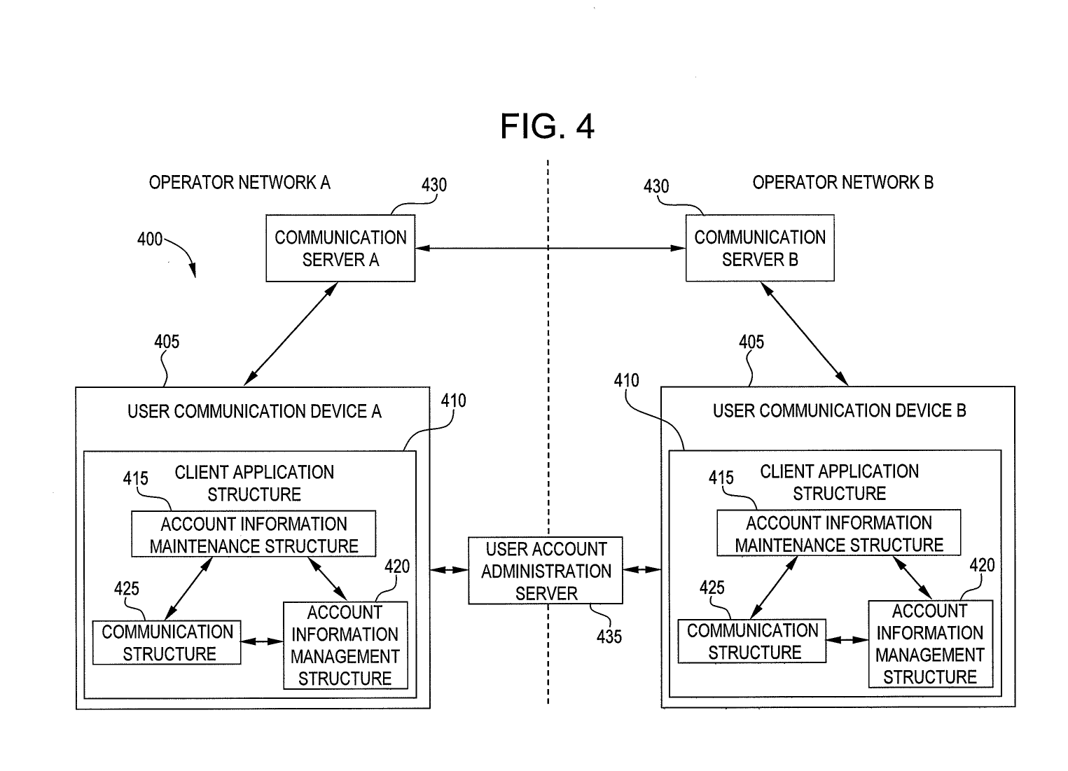

The exemplary embodiment illustrated in FIG. 2 can provide centralized, server-side porting of user accounts between communication systems. For example, such a centralized porting system can be used to perform bulk user account porting between communication environments. Alternatively, the user account portability functionality described herein can be performed on the client-side so as to distribute the functionality throughout the system. For purposes of illustration and not limitation, FIG. 4 is a block diagram illustrating a system 400 for porting user accounts between communication environments, in accordance with an alternative exemplary embodiment of the present invention. The exemplary embodiment illustrated in FIG. 4 can provide for distributed or de-centralized management of user account information across any and all operator networks. The system 400 includes one or more user communication devices 405 (e.g., user communication device A and user communication device B, although the system 400 can support any suitable number of such user communication devices 405). Each user communication device 405 is adapted to utilize a first communication service provided by a first communication service operator. For example, user communication device A is adapted to use the communication services provided by operator network A, while user communication device B is adapted to user the communication services provided by operator network B.

Each user communication device 405 includes client application structure 410 adapted to execute on the user communication device 405. According to an exemplary embodiment, the client application structure 410 can comprise the operating system software for running and operating the user communication device 405. Other applications or modules can be configured to run within such an operating system environment to provide other various and suitable features and functionality for the user communication device 405. According to an alternative exemplary embodiment, the client application structure 410 can comprise an application or other software that runs within an operating system that is provided by and with the user communication device 405. In such an alternative exemplary embodiment, the client application structure 410 can comprise one or a collection of application modules that provide the functionality described herein, in addition to other application modules that may be running or otherwise executing within the operating system environment provided by or with the user communication device 405. The actual implementation of the client application structure 410 will depend on the type of user communication device 405 and the functionality and features of such a device, and other like factors.

The client application structure 410 includes account information maintenance structure 415. The account information maintenance structure 415 is adapted to maintain or otherwise sustain communication account information associated with the user communication device 405 for configuring the first communication service for use by the user communication device 405 (e.g., in a manner similar to that described previously for the user account information repository module 215).

Each or any user communication device 405 can be switched at any desired time to a second communication service provided by a second communication service operator. For example, user communication device A can be switched to use the communication services provided by operator network B, while user communication device B can be switched to use the communication services provided by operator network A. Accordingly, the account information maintenance structure 415 is adapted for porting the communication account information from the first communication service operator to the second communication service operator for configuring the second communication service for use by the user communication device 415 (e.g., in a manner similar to that described previously for the user account information repository module 215).

The client application structure 410 of each user communication device 405 can include account information management structure 420. The account information management structure 420 can be adapted to manage communication account information associated with the user communication device 405 (e.g., in a manner similar to that described previously for the communication account information management module 225). The client application structure 410 of each user communication device 405 can also include communication structure 425. The communication structure 425 is adapted to communicate communication account information associated with the user communication device 405 (e.g., in a manner similar to that described previously for the communication module 230).

The system 400 can include suitable additional modules or components as necessary to assist or augment the functionality of the client application structure 410 of each user communication device 405. For example, the system 400 can include one or more communication servers 430 in communication with each other. Each communication server 430 can be in communication with one or more user communication devices 405. For example, communication server A can be in communication with user communication device A, and communication server B can be in communication with user communication device B. For example, each communication server 430 can be capable of being updated with the communication account information maintained by the account information maintenance structure 415 of the respective user communication device 405.

The present alternative exemplary embodiment can allow users to (manually or automatically) port their communication account information from one communication service provider to another via their user communication devices 405. In other words, the user communication devices 405 can be used for purposes of porting the communication account information of the user from the “old” communication service provider to a “new” communication service provider without having to rely on the communication service provider supporting such porting functionality. For purposes of illustration and not limitation, user A consumes the communication services within operator network A. Before user A decides to switch to operator network B, the user updates their user communication device A with the latest or most recent communication account information (either manually or automatically) using the account information maintenance structure 415 of the client application structure 410 to fetch such information from the communication server A. Such information can be cached or otherwise stored in and by the account information maintenance structure 415 until the user is ready to switch to another communication service provider. After switching and binding to operator network B, user A can update the communication server B with the communication account information stored locally on the user communication device A. Such user account portability functionality can be particularly useful in the situation where, for example, operator network A supports account portability according to exemplary embodiments, but operator network B does not, or vice versa.

The system 400 can also include a user account administration server 435 in communication with the client application structure 410 of each user communication device 405. The user account administration server 435 can be adapted to administer the client application structure 410 and the communication account information associated with the user communication device 405 (e.g., in a manner similar to that described previously for the user account administration module 235).

Other alternative architectures or structures can be used to implement the various functions of the systems 200 and 400 as described herein. For example, the client application structure 410 of the user communication devices 405 can instead reside in the respective communication servers 430. Alternatively, the user account portability functionality can be distributed between a central server or component (e.g., the user account management server module 205 illustrated in FIG. 2) and the user communication devices (e.g., the user communication devices 405 illustrated in FIG. 4) and/or the communication servers 430.

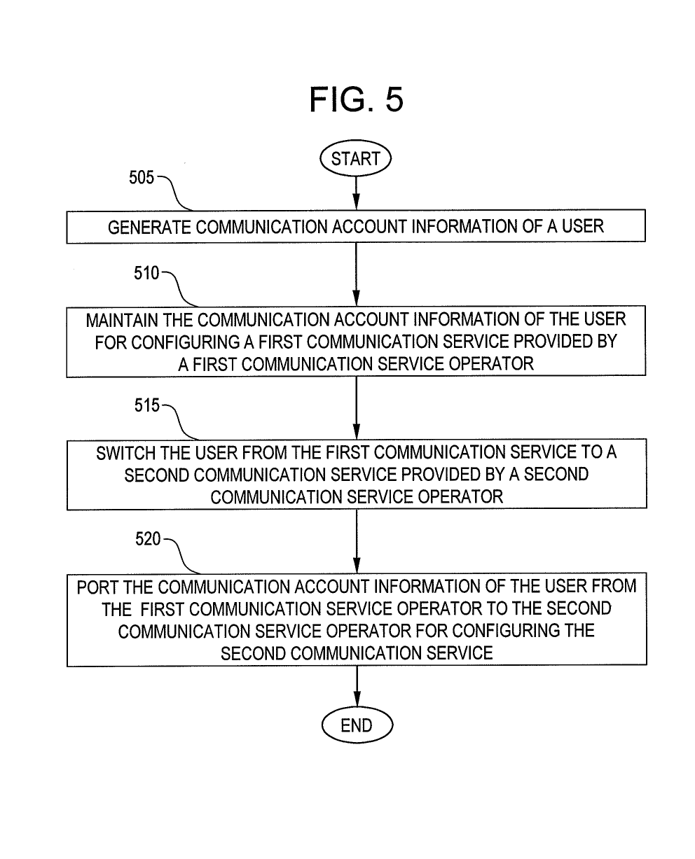

FIG. 5 is a flowchart illustrating steps for porting user accounts between communication environments, in accordance with an exemplary embodiment of the present invention. In step 505, communication account information of a user is generated. In step 510, the communication account information of the user is maintained for configuring a first communication service provided by a first communication service operator. In step 515, the user switches from the first communication service to a second communication service provided by a second communication service operator. In step 520, the communication account information of the user is ported from the first communication service operator to the second communication service operator for configuring the second communication service. For example, step 520 can include the step of querying for communication account information of the user (e.g., by the second communication service operator to retrieve the user's already-established settings, profiles, and preferences). The method can include one or more of the steps of: managing communication account information of the user; and communicating communication account information of the user. The method can also include the step of administering the communication account information of users.

Each, all or any combination of the steps of a computer program as illustrated in, for example, FIG. 5 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. As used herein, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CDROM).

Exemplary embodiments of the present invention can be used in conjunction with any wireless or wired device, system or process for communicating information. For example, exemplary embodiments can be used in presence- and IM-based communication systems, such as in mobile and fixed IM systems and the like.

It will be appreciated by those of ordinary skill in the art that the present invention can be embodied in various specific forms without departing from the spirit or essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

All United States patents and patent applications, foreign patents and patent applications, and publications discussed above are hereby incorporated by reference herein in their entireties to the same extent as if each individual patent, patent application, or publication was specifically and individually indicated to be incorporated by reference in its entirety.

What is claimed is:

1. A system for user account portability across communication systems, comprising:
a user account management server module capable of communicating with a plurality of communication service operators,
wherein the user account management server module comprises:
a user account information repository module,
wherein a user is configured to utilize a first communication service provided by a first communication service operator,
wherein the user account information repository module is configured to maintain communication account information of the user for configuring the first communication service for the user,
wherein the user switches to a second communication service provided by a second communication service operator, and
wherein the user account information repository module is configured for porting the communication account information of the user from the first communication service operator to the second communication service operator for configuring the second communication service for the user.

2. The system of claim 1, wherein the user account management server module comprises:
a communication account information management module,
wherein the communication account information management module is configured to manage communication account information of users.

3. The system of claim 1, wherein the user account management server module comprises:
a communication module,
wherein the communication module is configured to communicate communication account information of users.

4. The system of claim 3, wherein the communication module is configured to support a plurality of communication access protocols.

5. The system of claim 1, wherein each communication service operator comprises:
a communication server module in communication with the user account management server module,
wherein the communication server module is configured to query the user account management server module for communication account information of users.

6. The system of claim 1, wherein the communication account information of the user comprises user account information for each of a plurality of service accounts.

7. The system of claim 6, wherein the communication account information of the user comprises a plurality of user identity selectors for identifying user account information for each of the plurality of service accounts.

8. The system of claim 1, wherein the communication account information of the user comprises shared account information capable of being used by a plurality of communication services.

9. The system of claim 1, wherein each user comprises a user communication device, and
wherein each user communication device comprises the user account management server module.

10. The system of claim 1, comprising:
a user account administration module in communication with the user account management server module,
wherein the user account administration module is configured to administer the user account management server module and the communication account information of the users.

11. An system for porting user accounts between communication environments, comprising:
a user communication device,
wherein the user communication device is adapted to utilize a first communication service provided by a first communication service operator,
wherein the user communication device comprises:
client application structure adapted to execute on the user communication device,
wherein the client application structure comprises:
account information maintenance structure,
wherein the account information maintenance structure is adapted to maintain communication account information associated with the user communication device for configuring the first communication service for use by the user communication device,
wherein the user communication device is switched to a second communication service provided by a second communication service operator, and
wherein the account information maintenance structure is adapted for porting the communication account information from the first communication service operator to the second communication service operator for configuring the second communication service for use by the user communication device.

12. The system of claim 11, wherein the client application structure comprises:
account information management structure,
wherein the account information management structure is adapted to manage communication account information associated with the user communication device.

13. The system of claim 11, wherein the client application structure comprises:
communication structure,
wherein the communication structure is adapted to communicate communication account information associated with the user communication device.

14. The system of claim 11, wherein each communication service operator comprises:
a communication server,
wherein the communication server is capable of being updated with the communication account information maintained by the account information maintenance structure of the user communication device.

15. The system of claim 11, comprising:
a user account administration server in communication with the client application structure,
wherein the user account administration module is adapted to administer the client application structure and the communication account information associated with the user communication device.

16. A method of porting user accounts between communication environments, comprising the steps of:
a.) maintaining communication account information of a user for configuring a first communication service provided by a first communication service operator;
b.) switching the user from the first communication service to a second communication service provided by a second communication service operator; and
c.) porting the communication account information of the user from the first communication service operator to the second communication service operator for configuring the second communication service.

17. The method of claim 16, comprising the step of:
d.) generating the communication account information of the user.

18. The method of claim 16, comprising the step of:
d.) managing communication account information of the user.

19. The method of claim 16, comprising the step of:
d.) communicating communication account information of the user.

20. The method of claim 16, wherein step (c) comprises the step of:
d.) querying for communication account information of the user.

21. The method of claim 16, wherein the communication account information of the user comprises user account information for each of a plurality of service accounts.

22. The method of claim 21, wherein the communication account information of the user comprises a plurality of user identity selectors for identifying user account information for each of the plurality of service accounts.

23. The method of claim 16, wherein the communication account information of the user comprises shared account information capable of being used by a plurality of communication services.

24. The method of claim 16, comprising the step of:
d.) administering the communication account information of users.
